(19) United States
(12) Patent Application Publication
(10) Pub. No.: US 2005/0206621 A1
(43) Pub. Date: Sep. 22, 2005

(54) Optical pointing device

(75) Inventors: Carl Dennis, Edinburgh (GB); David Smith, Berwickshire (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Ltd., Marlow (GB)

(21) Appl. No.: 11/078,055

(22) Filed: Mar. 11, 2005

(30) Foreign Application Priority Data
Mar. 18, 2004 (EP) 04251537.9

(51) Int. Cl. G09G 5/08

(52) U.S. Cl. 345/166

(57) ABSTRACT

The optical pointing device, i.e. a computer mouse, includes an optical assembly, having a lens and light guide, that is formed integrally with a base or footplate. The optical assembly and the footplate are designed as a single, homogenous unit and are molded in a single operation. This device does not require assembly of separate components.

### FIELD OF THE INVENTION

The present invention relates to the field of computers and optics, and more particularly, to an optical pointing device.

### BACKGROUND OF THE INVENTION

The computer pointing device, more commonly called a computer mouse, has evolved from the older “ball mouse” to the modern “optical mouse”. The optical mouse incorporates a light source and optical elements with an image sensor that can view a surface across which the mouse is to be moved.

The image data is processed with a motion detection process, which translates changes in the images into motion, moving the display cursor accordingly. The optical mouse illuminates the image surface through a light guide, and a sensor sees the surface through a lens. A known optical assembly combines the light guide and lens into a single sub-unit, as shown in FIG. 1. During the mouse assembly process the optical assembly 10 must be located onto the mouse footplate or base 12.

This system necessitates the design and manufacture of two separate components, namely the footplate and secondly the optical assembly (lens with light guide). To successfully assemble these two distinct components, the footplate must incorporate additional features and tolerances specifically for aligning the optics.

The separate manufacture of the optical assembly and footplate results in several disadvantages, which include but are not limited to: (1) the separate assembly of two components is costly during manufacturing; (2) the complexity of the footplate design is increased to incorporate the optics; (3) the lens image circle must be increased to accommodate the optics to base registration tolerances; and (4) assembling two components always incurs a risk of error, reducing product quality.

### SUMMARY OF THE INVENTION

According to a first aspect of the present invention, an optical computer pointing device is provided that overcomes the disadvantages of the prior art.

The optical pointing device, i.e. a computer mouse, includes an optical assembly, having a lens and light guide, that is formed integrally with a base or footplate. The optical assembly and the footplate are designed as a single, homogenous unit and are molded in a single operation. This device does not require assembly of separate components.

### BRIEF DESCRIPTION OF THE DRAWINGS

The present invention will now be described by way of example only, with reference to the accompanying drawings, in which:

FIG. 1 is a bottom view showing a known optical computer pointing device.

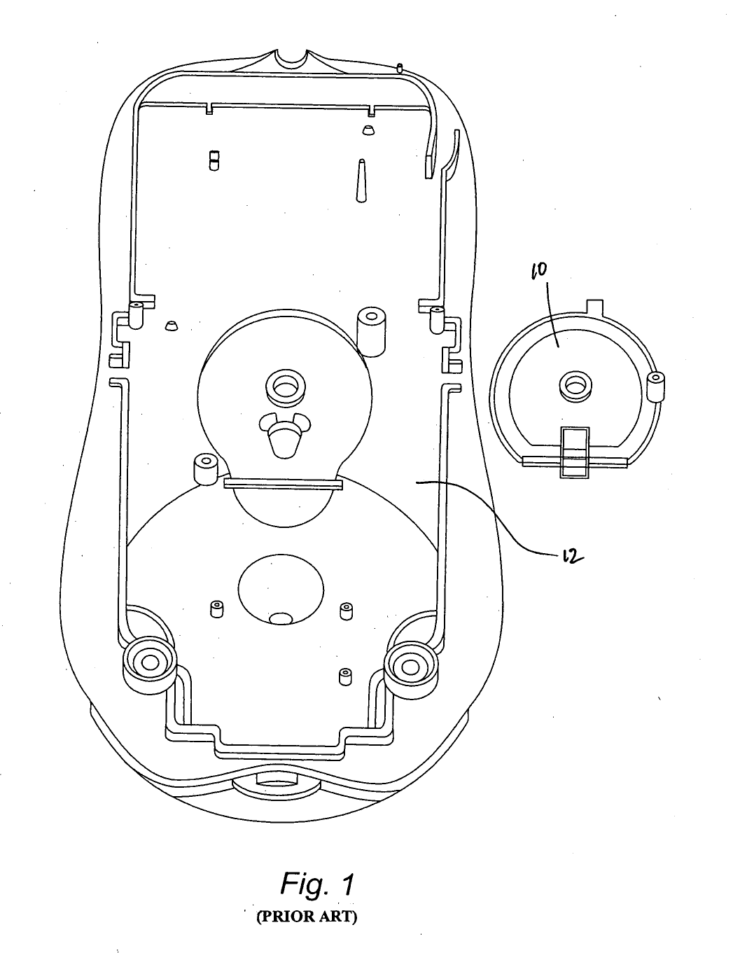

FIG. 2 is a bottom view showing an optical computer pointing device in accordance with an embodiment of the present invention.

### DETAILED DESCRIPTION OF THE PREFERRED EMBODIMENTS

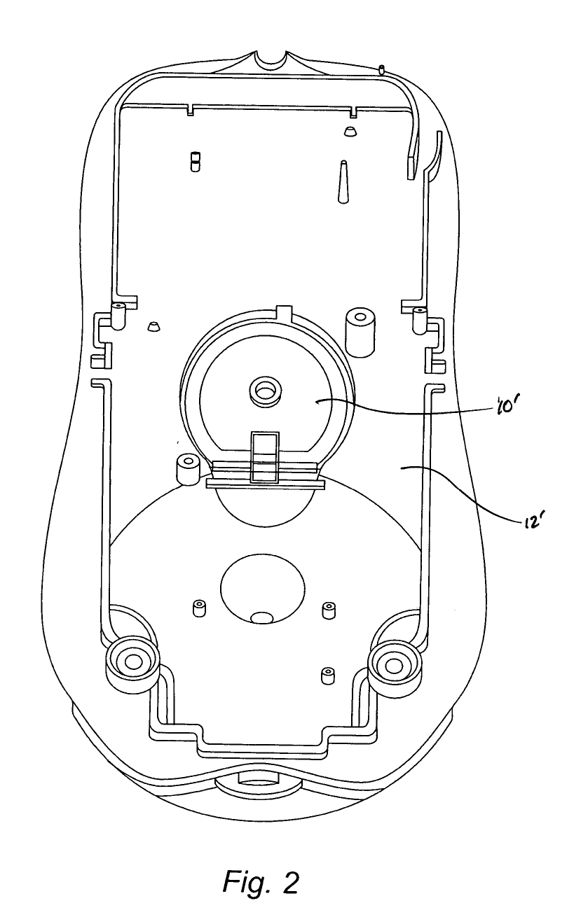

As shown in FIG. 2, the invention lies in creating the optical assembly 10′ as a feature of the footplate 12′, and producing the two features in a single unit. The optical assembly 10′ and the footplate 12′ are designed as a single, homogenous unit and are molded in a single operation. This system does not require assembly of separate components, which has several advantages over known two-piece designs. These advantages include but are not limited to: (1) no redundant design effort to facilitate the combination of the separate components; (2) the lens design is simplified because of a reduction in the size of the image circle—the sensor can be aligned directly to the lens; (3) component inventory management is improved—managing one component is simpler than two; (4) mouse assembly time and therefore the associated costs are reduced; and (5) product quality is improved by eliminating the risk of misassembly. In a two-piece design, there are registration tolerances between the footplate and the optical assembly, and also between the optical assembly and the light sensors on the PCB used to process the signals. The one piece design means that the registration tolerances between the footplate and optical assembly are eliminated. Additionally, the traditional mouse base with a separate optical assembly requires one larger or two smaller openings to permit illumination via a light guide to pass out of the mouse and, the image sensor via the lens optics to see the surface. However, these holes in the base permit dust, dirt and foreign objects to enter the mechanism. In the present invention, the light guide and lens optics are formed as an integral part of the base so holes are not required. Accordingly, ingress of dust, dirt and foreign objects into the mechanism is reduced.

The optical mouse, like all other electronic devices, is susceptible to damage (in extreme cases, total failure) due to Electrostatic Discharges (ESD). ESD protection circuits are built into the sensor electronics but these offer protection only to that component and only up to a predefined threshold, for example 4 KV. To further increase the threshold of damage from say 4 KV (a modest discharge, induced by a person simply walking on carpet or wearing clothes containing nylon) to say 15 KV (a strong discharge, possible by wearing shoes with insulating soles on a day with low humidity), optical components in a traditional mouse are extended with a flange or ring structure. In the present invention, this feature is not required because the base integrates this function. This significantly improves a product's resistance to ESD events.

Improvements and modifications can be made to the above without departing from the scope of the invention.

1-5. (canceled)

6. An optical computer pointing device comprising;
a footplate; and
an optical assembly integrally formed with the footplate as a monolithic unit.

7. The optical computer pointing device of claim 6, wherein the optical assembly comprises a lens and a light guide.

8. The optical computer pointing device of claim 6, wherein the optical assembly and footplate are formed from a same material.

9. An optical computer pointing device comprising;
a housing including a footplate for sliding on a surface;
an image sensor within the housing; and
an optical assembly integrally formed with the footplate as a monolithic unit.

10. The optical computer pointing device of claim 9, wherein the optical assembly comprises a lens and a light guide.

11. The optical computer pointing device of claim 9, wherein the optical assembly and base member are formed from a same material.

12. A method of making an optical computer pointing device comprising;
integrally forming an optical assembly with a footplate as a monolithic unit.

13. The method of claim 12, further comprising:
providing a housing including the footplate for sliding on a surface; and
providing an image sensor within the housing.

14. The method of claim 12, wherein the optical assembly comprises a lens and a light guide.

15. The method of claim 12, wherein the optical assembly and base member are formed from a same material.

16. The method of claim 9, wherein the monolithic unit is molded in a single operation.
